(19) United States
(12) Patent Application Publication
(10) Pub. No.: US 2020/0170268 A1
(43) Pub. Date: Jun. 4, 2020

(54) Treatment of Fresh Produce Material

(71) Applicant: J.W. European Ltd, Bosham Sussex (GB)

(72) Inventor: Scott Phillips, Bosham Sussex (GB)

(21) Appl. No.: 16/636,437

(22) PCT Filed: Jun. 29, 2018
(86) PCT No.: PCT/GB2018/051828

§ 371 Date: Feb. 4, 2020

(30) Foreign Application Priority Data
Aug. 4, 2017 (GB) 1712543.6

(51) Int. Cl. A23B 7/157; A23B 7/158

(52) U.S. Cl. CPC A23B 7/157; A23V 2002/00; A23B 7/158

(57) ABSTRACT

There is described a method of treating cut plant material, in particular a process of exposing cut plant material to a fog comprising sanitised water droplets comprising the steps of: providing a quantity of cut plant material; and exposing the plant material to a fog comprising sanitised water droplets. In the method the droplets impinge on the plant material at a velocity of at least 5 m/s, and the fog is released from one or more apertures, the lowest separation between the one or more apertures and the plant material being less than 3 mm, preferably less than 2 mm. The plant material may be exposed to the fog on its upward-facing side or on its downward-facing side. The method can reduce the extent of dehydration of cut plant material during processing and transportation while at the same time, offering a degree of sanitation of the product. An apparatus for carrying out the method is also described.

The present invention relates to the treatment of cut plant material, in particular to a process of exposing cut plant material to a fog comprising sanitised water droplets.

Herbs are available for sale in dried form (that is, desiccated form) or in fresh form. Fresh herbs are typically cut in the field, chilled, transported and then packed into plastic film or bags, prior to stocking in a retail environment. Cut salad leaves, baby leaves and spinach are most commonly available for sale in fresh form in a washed or an unwashed state. Like fresh herbs, the leaves are typically cut in the field or glasshouse, chilled, transported and then packed into plastic film or bags, prior to stocking in a retail environment. It is often found that this sequence of events results in partial dehydration of the fresh cut plant material, due to the low water vapour pressure in the external environment to which they are exposed. As a result, the consumer of unwashed leaves, in particular, may perceive a reduction in freshness of the leaves.

Thus, it is desirable to reduce the extent of dehydration of cut plant material during processing and transportation. At the same time, it is desirable to offer a degree of sanitation of the product, by reducing the quantity of microbes, typically by 90% or more. Acidified electrolysed water is known to be an effective and safe sanitiser of fresh produce, but adoption of this technology has been slow, since this modified water tends to degrade with time and can quickly lose its effectiveness.

Therefore, it is desirable to provide a method of treating cut plant material with sanitised water that helps to maintain the effectiveness of the sanitised water.

In a first aspect, the present invention may provide a method of treating cut plant material, comprising the steps of:
Providing a quantity of cut plant material; and
Exposing the plant material to a fog comprising sanitised water droplets, the droplets impinging on the plant material at a velocity of at least 5 m/s;
Wherein the fog is released from one or more apertures, the lowest separation between the one or more apertures and the plant material being less than 3 mm, preferably less than 2 mm.

The plant material may be exposed to the fog on its upward-facing side or on its downward-facing side. Preferably the plant material is exposed to the fog on its downward-facing side. In this case, the method typically comprises the steps of:
Providing a quantity of cut plant material, the plant material being supported on a porous membrane; and
Exposing the underside of the plant material to a fog comprising sanitised water droplets, the droplets impinging on the underside of the plant material at a velocity of at least 5 m/s;
Wherein the fog is released from one or more apertures positioned below the plant material, the distance between the one or more apertures and the upper surface of the porous membrane being less than 3 mm, preferably less than 2 mm.

Typically, the droplet size lies in the range 1-10 microns, preferably 3-10 microns. The term “droplet,” as used in this specification, includes microdroplets.

In certain cases, the droplets may impinge on the upward-facing or the downward-facing side of the plant material at a velocity of at least 7 m/s.

The sanitised water is provided by acidified electrically activated water. It has been found that acidified electrically activated water tends to degrade significantly when it is directed towards cut plant material via pressurised nozzles. It is thought that the high pressures experienced by the acidified electrically activated water when passing through the nozzles result in turbulent flow that causes the acidified electrically activated water to lose its potency.

The present invention aims to circumvent this problem by releasing a fog of acidified electrically activated water close to the surfaces of the cut plant material, such that the required impingement velocity of at least 5 m/s can be achieved without the need to pass the fog through highly pressurised nozzles.

By directing the water droplets towards the cut plant material at an imposed velocity of at least 5 m/s, the water droplets collide with the cut plant material and are absorbed by it via the stomata. This helps to prevent dehydration of the plant material and generally improves the consumer's impression of the freshness of the leaves, due to the increased plumpness of the leaves. The yield of the plant material (that is, the weight of the material that is e.g. sold to a consumer) is also increased, due to water being adsorbed or absorbed by the plant material, typically in an amount of between 2.5 and 7.5% relative to the weight of the plant material prior to treatment.

The sanitised water also reduces the quantity of microbes on the leaves, improving consumer safety and increasing shelf life.

By causing the water droplets to actively impinge on the cut plant material, it is possible to avoid the need to provide a temperature differential between the fog and the cut plants that would cause the fog to condense on the surfaces of the plant material. That is, it is possible to avoid the requirement for the temperature of the fog to be significantly greater than that of the plant material. Thus, the fog may be provided at a relatively chilled temperature of 10° C. or less.

By maintaining the fog temperature in this range, it is further possible to inhibit degradation of the sanitised water. A further advantage is that the produce is not heated by the fog.

Preferably, the temperature of the plant material prior to exposure to the fog is less than 10° C., preferably less than 8° C. In general, the temperature of the plant material prior to exposure to the fog is greater than 3° C.

Preferably, the time elapsing between the process of generating sanitised water and the impingement of the droplets of sanitised water on the plant material is less than 10 minutes. This further helps to inhibit degradation of the sanitised water before it collides with the plant material.

In order to achieve this, it is advantageous for at least two fog-generating machines (that is, evaporators or vaporisers) to be provided, each one being activated in turn. This helps to reduce the amount of time that sanitised water is held within each fog-generating machine, thus limiting the extent of degradation of the sanitised water within the machine. Preferably four or six fog-generating machines are provided, each one being operated in turn.

The acidified electrically activated water is generated through methods known in the art. Typically, the acidified electrically activated water has a charge of 1 to 1.5 V. In general, the electrically activated water has a chlorine content in the range 30-100 ppm, preferably 50-100 ppm. Typically, the chlorine is present in the form of hypochlorous acid.

Typically, the velocity of the fog results from its passage through a venturi system.

In general, the cut plant material is transported by means of a belt conveying system. In the case that the plant material is supported on a porous membrane, this porous membrane is typically provided by the conveyor belt of the belt conveying system.

Typically, the belt conveying system comprises first and second conveyor belts, the first and second conveyor belts being at different heights and at least partially overlapping in the vertical direction. This arrangement causes plant material to drop from the first conveyor belt to the second conveyor belt, generally turning in mid-air, such that on the second conveyor belt, a different side of the plant material is typically exposed to the fog than was the case on the first conveyor belt.

Typically, the first and second conveyor belts are configured such that the plant material is transported in a first direction on the first conveyor belt and in a second, opposite direction on the second conveyor belt. This allows the first and second conveyor belts to be stacked, so that they occupy less space.

Preferably, at least a section of the conveyor belt is agitated periodically or continuously e.g. through vibration. This may help to singulate the leaves, that is, to prevent the leaves becoming stacked on one another. In the case that the plant material is supported on a porous membrane, this agitation may help to dislodge any water droplets that may block the apertures in the porous membrane.

In the case that the plant material is supported on a porous membrane, one or more sheets of compressed air (for example, air knives) may impinge on the porous membrane. This may help to clean the membrane.

Typically, the cut plant material is exposed to the fog for a period greater than 0.5 minutes, preferably greater than 1 minute. In general, the exposure time is less than 5 minutes, preferably less than 3 minutes. However, a sufficient dwell time can be in the range 1-2 minutes.

To avoid a reduction in the quality of some treated plant material, it is generally desirable that the plant material should be wrapped in an impervious package within two minutes (preferably 1.5 minutes) after being exposed to the fog.

The cut plant material may be selected from the group comprising, for example, herbs, baby leaves, spinach and salad leaves.

In a second aspect, the present invention may provide an apparatus for treating fresh produce material, the apparatus comprising:
a conveyor belt, at least one section of which is porous;
at least one chamber for containing fog, the chamber being situated beneath a portion of the conveyor belt, the chamber having one or more apertures provided in its upper surface;
means for imparting a velocity to a fog and directing the fog into the at least one chamber;
wherein the distance between the upper surface of the chamber and the upper surface of the closest portion of the conveyor belt is less than 3 mm.

Preferably, the distance between the upper surface of the chamber and the upper surface of the closest portion of the conveyor belt is less than 2 mm.

Preferably the one or more apertures have a diameter of 3-5 mm.

Typically, the means for imparting a velocity to the fog is a venturi configuration.

In certain embodiments, a plenum is provided for housing fog before it is directed to the at least one chamber, the plenum having at least one pipe connecting it to the chamber. A duct is provided that extends through the plenum partially into the pipe, so that an open end of the duct is located within the pipe. The duct has a smaller diameter than the pipe.

This arrangement causes a drop in pressure to be created when air is passed along the duct and into the larger-diameter pipe. This drop in pressure draws fog from the plenum into the pipe and imparts velocity to it to cause the fog to travel into the chamber and through the one or more apertures in the upper surface of the chamber.

Typically, the apparatus further comprises:
a further conveyor belt, at least one section of which is porous;
at least one further chamber for containing fog, the further chamber being situated beneath a portion of the further conveyor belt, the further chamber having one or more apertures provided in its upper surface;
wherein the distance between the upper surface of the further chamber and the upper surface of the closest portion of the further conveyor belt is less than 3 mm.

Preferably, the distance between the upper surface of the further chamber and the upper surface of the closest portion of the further conveyor belt is less than 2 mm.

In this case, the means for imparting a velocity to the fog are adapted to direct the fog into the at least one further chamber, as well as the at least one chamber.

Typically, the conveyor belt and the further conveyor belt are at different heights and partially overlap in the vertical direction.

The invention will now be described by way of example with reference to the following

Figures in which:

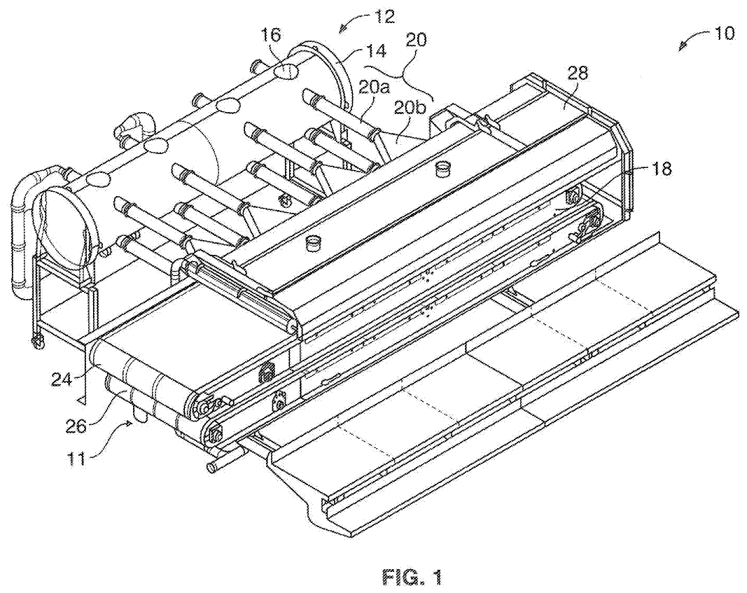

FIG. 1 shows a schematic perspective view of an apparatus for use in an example of the first aspect of the invention;

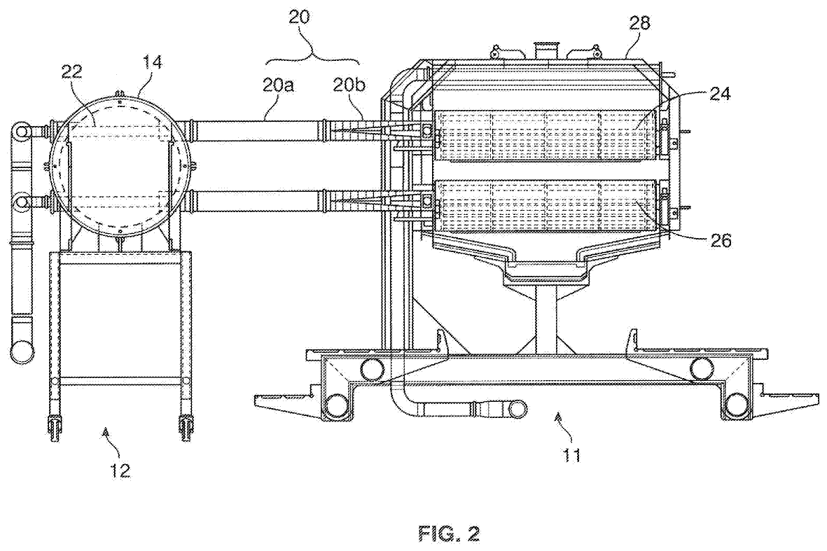

FIG. 2 shows a schematic cross-sectional view of the apparatus of FIG. 1;

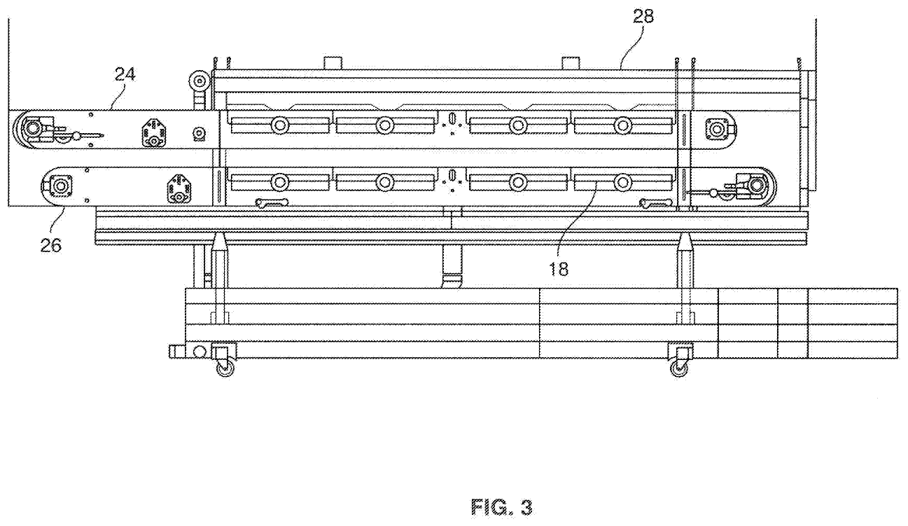

FIG. 3 shows a schematic side elevation view of the apparatus of FIG. 1;

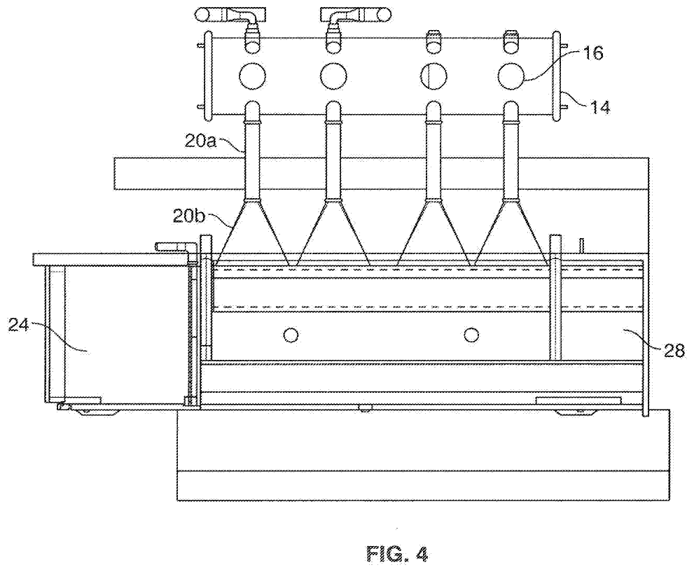

FIG. 4 shows a schematic plan view of the apparatus of FIG. 1;

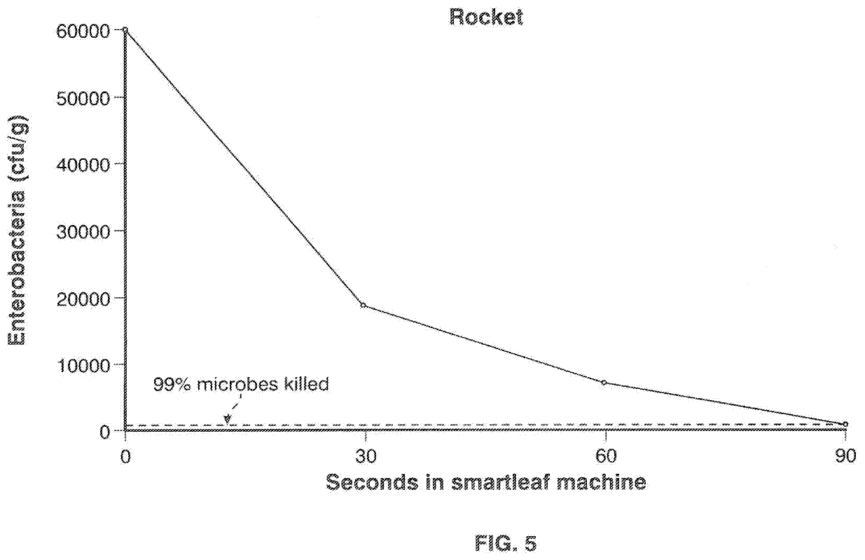

FIG. 5 is a chart showing a reduction in the microbes on leaves after carrying out the method according to the first aspect of the invention.

Referring to FIGS. 1-4, an apparatus 10 for the treatment of fresh produce material comprises a fog delivery system 12 and a belt conveying system 11.

Fog delivery system 12 comprises a plenum 14 having apertures 16 for receiving water vapour from a humidity generator (not shown). The plenum 14 is in fluid communication with fogging chambers 18 of the belt conveying system 11 via pipes 20. Each pipe 20 comprises a cylindrical portion 20a adjacent the plenum 14 and a flared portion 20b adjacent the respective chamber 18. Each flared portion 20b has a constant height, but flares outwardly in a lateral direction as it approaches the respective fogging chamber 18.

Referring to FIG. 2, air ducts 22 traverse plenum 14 and each have an open end within the cylindrical portion 20a of a respective pipe 20. The diameter of air ducts 22 is smaller than that of the cylindrical portions 20a of the pipes 20. Thus, the arrangement of the open end of air duct 22 within cylindrical portion 20a provides a venturi configuration.

Belt conveying system 11 comprises an upper conveyor belt 24 and a lower conveyor belt 26 that is located beneath the upper conveyor belt. The upper and lower conveyor belts are offset in a longitudinal direction of the belts. The conveyor belts are provided by a mesh material. A plurality of fogging chambers 18 is provided within each belt, each fogging chamber having an array of upwardly-facing apertures (not shown).

A hood 28 extends over a portion of the upper conveyor belt 24.

In use, acidified electrolysed water having a REDOX potential in the range 1100-1150 mV and a free chlorine content of 30-80 ppm is prepared through standard methods known in the art, chilled to a temperature of about 4-5° C., and delivered to a plurality of humidity generators, that is, fogging machines. Six fogging machines are provided and these are used in succession, such that the electrolysed water does not reside in any fogging machine for more than four minutes.

The fog from the fogging machines is delivered to plenum 14 via apertures 16 and is then accelerated through pipes 20 by means of the venturi effect created by the flow of air from the air ducts 22 into the pipes 20, which have a broader diameter. The accelerated fog is directed into chambers 18 and exits the chambers in an upwards direction via apertures (not shown) provided in the upper surface of the chambers.

Cut plant material, such as herbs or baby leaf salads, is held in a cold store, at a temperature of around 5° C., before being weighed and divided into portions of around 20-100 g. The plant material portions are placed onto upper conveyor belt 26 in pairs, the two portions in each pair being spaced apart in a lateral direction of the conveyor belt.

Conveyor belt 26 conveys the plant material towards hood 28. Beneath the hood 28, fog is directed towards the underside of the plant material through the apertures in the chambers 18 and the mesh of the conveyor belt 26. The velocity of the fog is in the range 5-10 m/s and the temperature of the fog lies in the range 3-5° C. Water droplets from the fog impinge on the plant material, thus helping to sanitise the material and promoting uptake of the water by the plant material.

The belt conveying system is configured to vibrate or otherwise agitate the plant material, so as to singulate the material (that is, to help reduce the incidence of leaves being piled on top of each other) and to help avoid the build-up of water on the belt, which would act to prevent fog passing through the mesh.

Once the plant material has travelled the length of the upper conveyor belt 26, it falls off and drops onto lower conveyor belt 24. This typically causes the plant material to turn over, such that a different side of the material is in contact with the conveyor belt. As the plant material travels along the lower conveyor belt 24, it is exposed to fog exiting the chambers 18 located within the lower conveyor belt. The fog passes through the mesh structure of the lower conveyor belt and impinges on the plant material at a velocity in the range 5-10 m/s.

The speed of the conveyor belt is around 2 m/min, such that the total exposure time of the plant material to the fog is around 2 minutes. After the plant material reaches the end of lower conveyor belt 24, it is weighed and wrapped as is known in the art.

FIG. 5 shows the number of enterobacteria present on a rocket sample (the data being given in the form of colony-forming units per gram of plant material) as a function of exposure time to droplets of sanitised water delivered according to the method of the first aspect of the invention. Each point represents five test results. The electrically activated water had a total chlorine content of 70 ppm, a charge of 1150 mV and a pH of 3.5. The temperature of the water droplets and the plant material lay in the range 4-5° C.

The results show a sharp drop in the number of bacteria as a function of exposure time to the sanitised water. The decrease in the number of bacteria between 0 and 90 seconds is statistically significant, having a P value less than 0.05.

1. A method of treating cut plant material, comprising the steps of:
Providing a quantity of cut plant material; and
Exposing the plant material to a fog comprising sanitised water droplets, the droplets impinging on the plant material at a velocity of at least 5 m/s;
Wherein the fog is released from one or more apertures, the lowest separation between the one or more apertures and the plant material being less than 3 mm.

2. The method of claim 1, wherein the plant material is supported on a porous membrane and the droplets impinge on the underside of the plant material.

3. The method of claim 2, wherein the temperature of the sanitised water droplets lies in the range of 3-10° C.

4. The method of claim 3, wherein the impingement of the droplets on the plant material occurs less than 10 minutes after the generation of the sanitised water comprised in those droplets.

5. The method of claim 4, wherein at least two fog-generating means are provided, each fog-generating apparatus being activated in turn.

6. The method of claim 5, wherein the sanitised water has a charge of 1 to 1.5 V.

7. The method of claim 6, wherein the sanitised water has a chlorine content in the range of 30-100 ppm.

8. The method of claim 7, wherein the sanitised water contains chlorine in the form of hypochlorous acid.

9. The method of claim 8, wherein prior to the step of releasing fog from the one or more apertures, the velocity of the fog is increased by means of a venturi system.

10. The method of claim 9, wherein the plant material is supported on a porous membrane and the droplets impinge on the underside of the plant material, and further wherein the cut plant material is transported by means of a belt conveying system and the porous membrane is provided by the conveyor belt of the belt conveying system.

11. The method of claim 10, wherein the belt conveying system comprises first and second conveyor belts, the first and second conveyor belts being at different heights and partially overlap in the vertical direction.

12. The method of claim 11, wherein the first and second conveyor belts are configured such that the plant material is transported in a first direction on the first conveyor belt and in a second, opposite direction on the second conveyor belt.

13. The method of claim 12, wherein the plant material is supported on a porous membrane and the droplets impinge on the underside of the plant material, and further wherein the porous membrane is agitated periodically or continuously.

14. The method of claim 13, wherein the plant material is supported on a porous membrane and the droplets impinge on the underside of the plant material, and further wherein one or more sheets of compressed air impinge on the porous membrane.

15. The method of claim 14, wherein the droplet size lies in the range 1-10 microns.

16. The method of claim 15, wherein the cut plant material is exposed to the fog for a period in the range 1-5 minutes.

17. The method of claim 16, wherein the cut plant material is selected from the group comprising: herbs, baby leaves, spinach and salad leaves.

18. An apparatus for treating fresh produce material, the apparatus comprising:
a conveyor belt, at least one section of which is porous;
at least one chamber for containing fog, the chamber being situated beneath a portion of the conveyor belt, the chamber having one or more apertures provided in its upper surface;
means for imparting a velocity to a fog and directing the fog into the at least one chamber;
wherein the distance between the upper surface of the chamber and the upper surface of the closest portion of the conveyor belt is less than 3 mm.

19. The apparatus of claim 18, wherein the means for imparting a velocity to the fog is a venturi configuration.

20. The apparatus of claim 19, comprising means for agitating at least a portion of the conveyor belt.

21. The apparatus of claim 20, wherein the apparatus further comprises:
a further conveyor belt, at least one section of which is porous; and
at least one further chamber for containing fog, the further chamber being situated beneath a portion of the further conveyor belt, the further chamber having one or more apertures provided in its upper surface;
wherein the distance between the upper surface of the further chamber and the upper surface of the closest portion of the further conveyor belt is less than 3 mm.

22. The apparatus of claim 21, wherein the conveyor belt and the further conveyor belt are at different heights and partially overlap in the vertical direction.
